(19) United States
(12) Patent Application Publication
(10) Pub. No.: US 2019/0299091 A1
(43) Pub. Date: Oct. 3, 2019

(54) DISPLAY CONTROL METHOD AND APPARATUS FOR GAME SCREEN, STORAGE MEDIUM, AND ELECTRONIC DEVICE

(71) Applicant: NETEASE (HANGZHOU) NETWORK CO.,LTD., Hangzhou (CN)

(72) Inventors: Zhiwu WU, Hangzhou (CN); Huifei BAO, Hangzhou (CN)

(73) Assignee: NETEASE (HANGZHOU) NETWORK CO.,LTD., Hangzhou (CN)

(21) Appl. No.: 16/346,141

(22) PCT Filed: Mar. 21, 2018
(86) PCT No.: PCT/CN2018/079756

§ 371 Date: Apr. 30, 2019

(30) Foreign Application Priority Data
Mar. 27, 2017 (CN) 201710188700.1

(51) Int. Cl. A63F 13/2145; G06F 3/0488; A63F 13/56; A63F 13/52

(52) U.S. Cl. CPC A63F 13/2145; A63F 13/52; A63F 13/56; G06F 3/0488

(57) ABSTRACT

The present disclosure provides a display control method and apparatus for a game screen, a storage medium, and an electronic device, and the method comprises: providing a first touch control region on the graphical user interface, and configuring the virtual character to perform at least one of displacement and rotation in the game scene according to a first touch operation received by the first touch control region; providing a second touch control region on the graphical user interface, and when a second touch operation in the second touch control region is detected, changing the presented visual field of the game scene on the graphical user interface; when an end of the second touch operation is detected, controlling the presented visual field of the game scene on the graphical user interface to be restored to a state before the second touch operation.

### CROSS REFERENCE

The present application is a continuing application of International Application No. PCT/CN2018/079756, filed on Mar. 21, 2018, which is based upon and claims priority to Chine Patent Application No. 2017101887001 filed on March 27, 2017 and the entire contents thereof are incorporation herein by reference.

### TECHNICAL FIELD

The present disclosure relates to the field of computer interaction technologies, and particularly to a display control method and apparatus for a game screen, a storage medium, and an electronic device.

### BACKGROUND

With the development of mobile intelligent terminals and game industry, a large number of mobile games with different themes have emerged to meet the needs of users. In the game, the virtual characters all look forward by default. If it is desired to observe the virtual environment behind or around the virtual character in the virtual environment where the virtual character is located, it must be done by rotating the orientation of the virtual character.

### SUMMARY

According to a first aspect of the present disclosure, it provides a display control method for a game screen, wherein a graphical user interface is obtained by executing a software application on a processor of a mobile terminal and rendering on a touch screen of the mobile terminal, contents displayed by the graphical user interface including a game scene and a partial virtual character, and the method comprises:

providing a first touch control region on the graphical user interface (GUI), and configuring the virtual character to perform at least one of the following actions: displacement and rotation in the game scene according to a first touch operation received by the first touch control region;

providing a second touch control region on the graphical user interface, and configuring a presented visual field of the game scene on the graphical user interface to be changed according to a second touch operation received by the second touch control region;

detecting the second touch operation in the second touch control region, and changing the presented visual field of the game scene on the graphical user interface according to the second touch operation;

and when an end of the second touch operation is detected, controlling the presented visual field of the game scene on the graphical user interface to be restored to a state before the second touch operation.

According to a second aspect of the present disclosure, it provides a display control apparatus for a game screen, the game screen comprising a graphical user interface obtained by executing a software application on a processor of a mobile terminal and rendering on a display of the mobile terminal. The content presented by the graphical user interface includes a game scene and at least partially includes a virtual character, and the apparatus comprises:

a first providing component, configured to provide a first touch control region on the graphical user interface, and to configure the virtual character perform at least one of the following actions: displacement and rotation in the game scene according to a first touch operation received by the first touch control region;

a second providing component, configured to provide a second touch control region on the graphical user interface, and to configure a presented visual field of the game scene on the graphical user interface to be changed according to a second touch operation received by the second touch control region;

a first detecting component, configured to detect the second touch operation located in the second touch control region, and to change the presented visual field of the game scene on the graphical user interface according to the second touch operation;

and a second detecting component, configured to detect end of the second touch operation, and to control the presented visual field of the game scene on the graphical user interface to be restored to a state before the second touch operation.

According to ma third aspect of the present disclosure, it provides a computer readable storage medium stored with a computer program, wherein the display control method for a game screen according to any one of the above items is implemented when the computer program is executed by a processor.

According to fourth aspect of the present disclosure, it provides an electronic device, comprising:

a processor; and

a storage device configured to store an executable instruction of the processor;

wherein the processor is configured to perform the aforesaid display control method for a game screen.

### BRIEF DESCRIPTION OF THE DRAWINGS

FIG. 1 is a flowchart of a display control method of a game screen according to the present disclosure;

FIG. 2 is a cross-sectional view of a game scene provided by an illustrative embodiment of the present disclosure;

FIG. 3 is a schematic diagram of changing a presented visual field according to a swipe operation according to an illustrative embodiment of the present disclosure;

FIG. 4 is a block diagram of a display control apparatus for a game screen according to the present disclosure;

FIG. 5 is a component schematic diagram of an electronic device in an illustrative embodiment of the present disclosure.

### DETAILED DESCRIPTION

Illustrative embodiments of the present disclosure will be described more comprehensively with reference to the drawings. However, the illustrative embodiments can be implemented in various forms and are not interpreted in a limited way. On the contrary, these embodiments are provided in order to make the present disclosure comprehensive and complete and to fully convey concept(s) of the illustrative embodiments to those skilled in the art. The described features, structures, or characteristics may be combined in any suitable manner in one or more embodiments. In the following description, numerous specific details are set forth to provide a thorough understanding of the embodiments of the disclosure. However, those skilled in the art will appreciate that the technical solution of the present disclosure may be practiced without one or more of the specific details, or employing other methods, components, materials, apparatus, steps, and the like. In other instances, well-known technical solutions are not shown or described in detail to avoid obscuring aspects of the present disclosure.

In addition, the drawings are merely schematic illustrations of the present disclosure, and are not necessarily drawn to scale. Similar reference numerals in the drawings indicate the same or similar portions, with repeated description thereof omitted.

However, in a mobile terminal (especially a mobile terminal employing touch control), it is a great limitation to observe the surrounding environment by controlling the rotation of the virtual character, on one hand, the operability is poor and not convenient, on the other hand, it will interrupt of change the combat state of the virtual character by controlling the rotation of the virtual character to observe the surrounding environment, thus it is unable to switch in the battle or it affects the progress of the battle, the user's need for the visual field switching cannot be satisfied, and the user experience is not good.

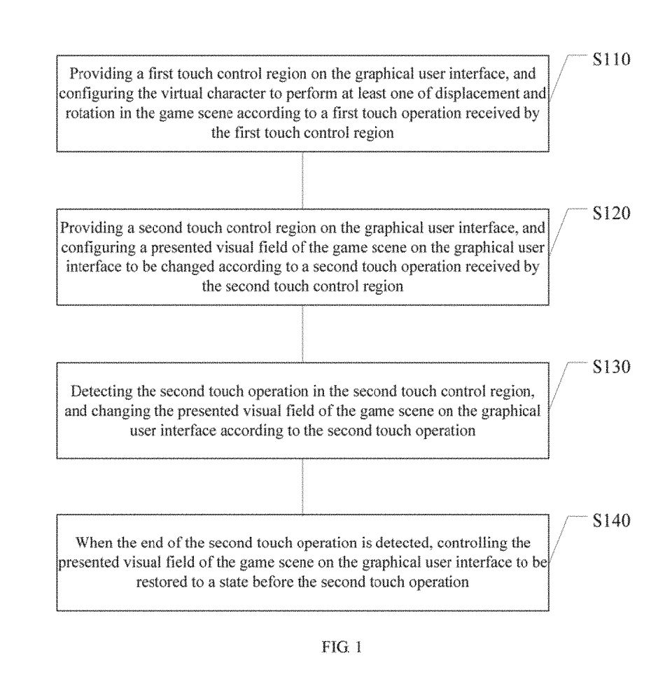

The present illustrative embodiment firstly discloses a display control method for a game screen, wherein a graphical user interface is obtained by executing a software application on a processor of a mobile terminal and rendering on a touch screen of the mobile terminal, contents displayed by the graphical user interface including a game scene and a partial virtual character. Referring to FIG. 1, the display control method for a game screen may comprise the following steps.

In step S110, a first touch control region is provided on the graphical user interface, and the virtual character is configured to perform ate least one of the following actions: displacement and rotation in the game scene according to a first touch operation received by the first touch control region.

In step S120, a second touch control region is provided on the graphical user interface, and a presented visual field of the game scene on the graphical user interface is configured to be changed according to a second touch operation received by the second touch control region.

In step S130, when the second touch operation is detected in the second touch control region, the presented visual field of the game scene on the graphical user interface is changed according to the second touch operation.

In step S140, when an end of the second touch operation is detected, the presented visual field of the game scene on the graphical user interface is controlled to be restored to a state before the second touch operation.

By the display control method of a game screen in the present illustrative embodiment, on one hand, by providing the first touch control region on the graphical user interface and according to the detected first touch operation occurring in the second touch control region, i.e., at least one of displacement and rotation may be performed in the game scene according to the first touch operation received by the first touch control region; on the other hand, by providing the second touch control region on the graphical user interface and according to the detected second touch operation occurring in the second touch control region, i.e., the presented visual field of the game scene on the graphical user interface may be changed according to the second touch operation received by the second touch control region, when the second touch operation ends, the presented visual field of the game scene on the graphical user interface is restored to the original state. The second touch operation of the user in the second touch control region may change the presented visual field of the game scene on the graphical user interface, and when the second touch operation ends, the state is restored to a state before the second touch operation, providing the user with a convenient and fast way to adjust the presented visual field to meet the needs of the user and improve the user experience.

Hereinafter, each step of the display control method for a game screen in the present illustrative embodiment will be further explained.

In step S110, a first touch control region is provided on the graphical user interface, and a virtual character is configured to perform at least one of the following actions: displacement and rotation in the game scene according to a first touch operation received by the first touch control region;

The first touch control region may be, for example, a virtual joystick control region, a direction control virtual key region, and the like, which is not specifically limited in the present illustrative embodiment.

In an alternative embodiment, the first touch control region is a virtual joystick control region, and the virtual character is controlled to perform at least one of the following actions: displacement and rotation in the game scene according to the first touch operation received by the virtual joystick control region.

In an alternative embodiment, the first touch control region is a virtual cross key region/virtual direction key (D-PAD) region, and the virtual character is controlled to fee perform at least one of the following actions: displacement and rotation in the game scene according to the first touch operation received by the virtual cross key region.

In an alternative embodiment, the first touch control region is a touch control region with a visual indication, for example, a touch control region with a bounding box, or a touch control region filled with a color, or a touch control region with a predetermined transparency, or other control region capable of visually indicating the range of the first touch control region, and the virtual character is controlled to perform at least one of the following actions, displacement and rotation in the game scene according to a touch operation such as a swipe, a click, or the like received by the touch control region. The touch control region with a visual indication enables the user to quickly locate the touch control region, which can reduce the difficulty of operation for a game novice.

In an alternative embodiment, the first touch control region is a touch control region with no visual indication on the graphical user interface. The touch control region with no visual indication will not cover or affect the game screen, provide better picture effects, and save screen space, and is suitable for the operation of a game master.

The displacement of the virtual character in the game scene refers to the change of the position of the virtual character in the game scene; the rotation of the virtual character in the game scene refers to the change of the orientation of the virtual character in the game scene.

By providing the first touch control region on the graphical user interface and according to the detected first touch operation occurring in the first touch control region, i.e., at least one of displacement and rotation may be performed in the game scene according to the first touch operation received by the first touch control region

In step S120, a second touch control region is provided on the graphical user interface, and a presented visual field of the game scene on the graphical user interface is configured to be changed according to a second touch operation received by the second touch control region.

The second touch control region is a touch control region with a visual indication on the graphical user interface, for example, a touch control region with a bounding box, or a touch control region filled with a color, or a touch control region with a predetermined transparency, or other control region capable of visually indicating the range of the second touch control region. The touch control region with a visual indication enables the user to quickly locate the touch control region, which can reduce the difficulty of operation for a game novice.

In an alternative embodiment, the second touch control region is a touch control region with no visual indication on the graphical user interface. The touch control region with no visual indication will not cover or affect the game screen, provide better picture effects, and save screen space, and is suitable for the operation of a game master.

The change in the presented visual field of the game scene on the graphical user interface includes at least one of: a change in the presentation range of the game scene on the graphical user interface, and a change in the presentation angle of the game scene on the graphical user interface, and when the presented visual field of the game scene on the graphical user interface changes according to the second touch operation received by the second touch control region, the orientation of the virtual character and the position of the crosshair do not change.

The change of the presented visual field of the game scene on the graphical user interface will be described below in combination with an example.

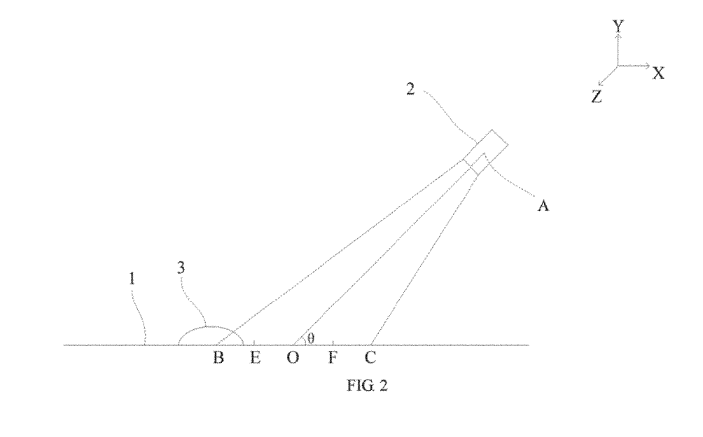

FIG. 2 shows a cross-sectional view of a game scene in the XY coordinate plane as shown in FIG. 2, the Z direction is a direction perpendicular to the paper surface (XY plane) and facing outward, wherein 1 is a game scene, 2 is a virtual camera, and 3 is a hillside in the game scene. The virtual camera 2 is set at point A, the angle of the shooting direction line OA is Θ, and point O is the intersection of the shooting direction line passing through point A and the game scene 1. The content of the game scene rendered on the display of a mobile terminal is equivalent to the scene content captured by the virtual camera 2, ranging from point B to point C.

When the virtual camera 2 advances along the shooting direction line AO to

the game scene 1, the presentation range of the game scene on the graphical user interface becomes smaller, and the presentation angle does not change; otherwise, the presentation range becomes larger and the presentation angle does not change;

When the game scene is small, for example, the game scene range is limited to from point E to point F, and within a certain range of shooting angles, the virtual camera 2 can capture the full range of the game scene. In this case, the position of the virtual camera 2 is kept unchanged at point A, and the shooting angle Θ is changed within a certain range, the presentation angle of the game scene on the graphical user interface changes, and the presentation range does not change.

In an alternative embodiment, when a preset touch operation on the graphical user interface is detected, a second touch control region is provided on the graphical user interface.

For example, when a preset touch operation such as a heavy press, a long press, or a double-click on the graphical user interface is detected, the second touch control region is provided on the graphical user interface, and the presented visual field of the game scene on the graphical user interface is configured to be changed according to a second touch operation received by the second touch control region. In this way, the user can call up the second touch control region as needed, avoiding misoperation and saving screen space.

In an alternative embodiment, an option is provided in the setting of the game software application for the user to select. Whether the function of providing the second touch control region is turned-on on the graphical user interface is determined according to the content of the setting option.

In an alternative embodiment, the above step S120 may be performed before step S110. That is, the order of the above steps S110 and S120 is not limited.

In step S130, the second touch operation in the second touch control region is detected, and the presented visual field of the game scene on the graphical user interface is changed according to the second touch operation;

The second touch operation is a sliding touch operation, and the presented visual field of the game scene on the graphical user interface is changed according to the sliding trajectory of the sliding touch operation, and the adjustment direction of the presented visual field of the game scene on the graphical user interface is the same as the sliding direction, and when the presented visual field of the game scene changes, the orientation of the virtual character and the position of the crosshair do not change.

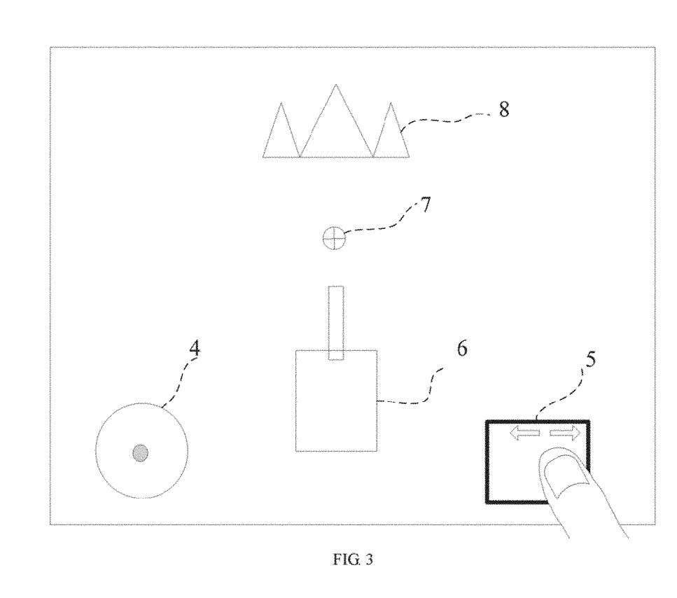

As shown in FIG. 2 and FIG. 3, when the second touch control region receives a sliding touch operation in the right direction, the presented visual field of the game scene on the graphical user interface changes, which is equivalent to the virtual camera 2 rotating in the negative direction of the Z axis. The angle of rotation is determined by the distance of the swiping, and the larger the sliding distance is, the larger the angle of rotation is.

As shown in FIG. 3, the user-controlled virtual character 6 is a tank, and the tank orientation and the weapon crosshair 7 are both pointed to the reference object 8 (for example, a mountain). The user may control at least one of displacement and rotation of the tank through a first touch control region 4 (e.g., a virtual joystick region) located on the left side of the graphical user interface. The presented visual field of the game scene is adjusted by a second touch control region 5 located on the right side of the graphical user interface (e.g., a region with a bounding box on the right side in FIG. 3). When the finger swipes left or right in the second touch control region 5, the game scene presents a corresponding left or right adjustment of the visual field, and when the presented visual field is adjusted to the left or right accordingly, the orientation of the virtual character 6 tank and the weapon crosshair 7 are all directed to the reference object 8.

When a sliding touch operation of sliding to the lower right direction is received, the presented visual field of the game scene on the graphical user interface changes, which corresponds to the virtual camera 2 in FIG. 2 rotating in the negative direction of the Z axis and rotating in the Y negative direction.

Similarly, the presented visual field is changed accordingly by receiving a sliding touch operation in other directions.

In an alternative embodiment, the adjustment direction of the presented visual field of the game scene on the graphical user interface is opposite to the sliding direction.

For example, as shown in FIG. 3, the user-controlled virtual character is a tank, and the tank orientation and the weapon crosshair are both pointed to the mountain. The user may control at least one of the displacement and/or the rotation of the tank through the first touch control region (e.g., a virtual joystick region) located on the left side of the graphical user interface. The presented visual field of the game scene is adjusted by the second touch control region located on the right side of the graphical user interface (the region with a bounding box on the right side in FIG. 3). When the finger swipes to the right in the second touch control region, the presented visual field of the game scene is correspondingly adjusted to the left, which corresponds to the virtual camera 2 in FIG. 2 rotating in the positive direction of the Z axis.

In an alternative embodiment, changing the presented visual field of the game scene on the graphical user interface according to the sliding trajectory of the sliding touch operation is equivalent to changing the position A of the virtual camera and changing the shooting direction of the virtual camera 2.

For example, when the initial operation of the sliding touch operation is detected, the position of the virtual camera 2 in the game scene is changed to a preset position and the direction of the virtual camera is changed according to the sliding trajectory of the sliding touch operation, i.e., the direction of the presented visual field of the game scene on the graphical user interface is changed according to the sliding trajectory of the sliding touch operation. For example, when the initial operation of the sliding touch operation is detected, the first person view game screen is switched to the third person view game screen, which, at this time, corresponds to changing the position of the virtual camera 2, and changing the direction of the presentation visual view of the game scene on the graphical user interface according to the sliding trajectory of the sliding touch operation.

The second touch operation is a sliding touch operation, and the position of the virtual camera is changed according to the sliding trajectory of the sliding touch operation to change the presented visual field of the game scene on the graphical user interface.

For example, in FIGS. 2-3, when the finger swipes left or right in the second touch control region 5, the game screen presents a corresponding left or right adjustment of the presented visual field, which corresponds to the corresponding movement of the virtual camera 2 in FIG. 2 along the Z axis; when the finger swipes up or down in the second touch control region 5, the game screen presents a corresponding up or down adjustment of the presented visual field, which corresponds to the corresponding movement of the virtual camera 2 in FIG. 2 along the Y axis.

In an alternative embodiment, the second touch operation is a touch click operation, and the presented visual field of the game scene on the graphical user interface is changed according to the click position of the touch click operation and the position of a preset point in the second touch control region.

For example, the preset point is the center point of the second touch control region, and the click position of the touch click operation is on the right side of the center point, thus the presented visual field is adjusted to turn to the right. Similarly, the presented visual field is adjusted accordingly by receiving a touch click operation in other directions.

For example, the preset point is the center point of the second touch control region, and the click position of the touch click operation is on the right side of the center point, thus the position of the virtual camera is controlled to move to the right. Similarly, the presented visual field is adjusted accordingly by receiving a touch click operation in other directions.

In an alternative embodiment, the second touch operation is a touch click operation, and the presented visual field of the game scene on the graphical user interface is changed according to the click position of the touch click operation and the position of a preset line in the second touch control region. For example, the preset line is the center line in the horizontal direction of the second touch control region, the click position of the touch click operation is on the right side of the center line, thus the presented visual field is adjusted to turn to the right; and the click position of the touch click operation is on the left side of the center line, thus the presented visual field is adjusted to turn, to the left. For another example, the preset line is the center line in the vertical direction of the second touch control region, the click position of the touch click operation is on the upper side of the center line, thus the presented visual field is adjusted to turn up; and the click position of the touch click operation is on the lower side of the center line, thus the presented visual field is adjusted to turn down.

For example, the preset line is the center line in the horizontal direction of the second touch control region, the click position of the touch click operation is on the right side of the center line, thus the position of the virtual camera is controlled to move to the right; and the click position of the touch click operation is on the left side of the center line, thus the position of the virtual camera is controlled to move to the left. For example, the preset line is the center line in the vertical direction of the second touch control region, the click position of the touch click operation is on the upper side of the center line, thus the position of the virtual camera is controlled to move up; and the click position of the touch click operation is on the lower side of the center line, thus the position of the virtual camera is controlled to move down.

In step S140, when the end of the second touch operation is detected, the presented visual field of the game scene on the graphical user interface is controlled to be restored to the state before the second touch operation.

The end of the second touch operation refers to a finger or other touch object leaving the touch screen.

For example, when the second touch operation is a sliding touch operation, the user raises the finger to restore the current presented visual field to the state before the sliding touch operation.

The game user can change the direction of the presented visual field of the game scene on the graphical user interface by a swipe touch operation, and does not change the orientation of the virtual character and the direction of the weapon crosshair. After the sliding touch operation is finished, the game screen presented on the terminal can be quickly restored. A convenient and fast way to adjust the visual field is provided.

It should be noted that the restoration of the presented visual field to the state before the second touch operation according to the present disclosure comprises: controlling the presented visual field of the game scene on the graphical user interface to be restored to a presented visual field before the second touch operation; or controlling the presented visual field of the game scene on the graphical user interface to be restored to a logically calculated presented visual field calculated according to a presented visual field before the second operation.

The presented visual field of the game scene on the graphical user interface is controlled to be restored to the presented visual field before the second touch operation, that is, the presented visual field is absolutely restored to the state before the second touch operation: the absolute position and the absolute angle/direction of the virtual camera of the game screen are restored to the state before the second touch operation. For example, before the second touch operation, the position of the virtual camera 2 is point A in the absolute coordinates of the game scene, and the shooting direction is direction vector AO; absolutely restoration of the presented visual field to the state before the second touch operation is based on the A point and the direction AO for absolute restoration, that is, based on the position and the shooting direction of the virtual camera in the absolute coordinates of the game scene before the second touch operation, the presented visual field of the game scene on the graphical user interface is controlled.

The presented visual field of the game scene on the graphical user interface is controlled to be restored to a logically calculated presented visual field calculated according to a presented visual field before the second operation, that is, the visual field is restored to the control state before the second touch operation. For example, before the second touch operation, the game calculates the visual field according to predetermined computational logic (for example, the virtual camera is placed at the head of the virtual character and rotates following the rotation of the virtual character). In this case, the restoration of the visual field to the state before the second touch operation according to the present disclosure may also be to resume computational logic before the second touch operation to calculate the visual field. For example, before the second touch operation, the position of the virtual camera 2 is point A in the relative coordinates associated with the virtual character (e.g., a point behind the virtual character with a distance of W and a height of H), and the shooting direction is the direction vector AO, which is associated with the orientation of at least one of the virtual character and the crosshair direction of the weapon (e.g., the projection of the direction vector AO in the horizontal direction is the same as the orientation of the virtual character in the horizontal direction). At the time of restoration, the position of the virtual camera 2 is still located at the point behind the virtual character with the distance of W and the height of H, and the shooting direction of the virtual camera 2 is associated with at least one of the orientation of the virtual character and the crosshair direction of the weapon. That is, the presented visual field of the game scene on the graphical user interface is controlled based on the current position of the virtual character in the absolute coordinates of the game scene, at least one of the orientation of the current virtual character and the weapon crosshair direction of the virtual character, positional relationship of the virtual camera in the game scene relative to the virtual character before the second touch operation, and at least one of the relationship between the orientation of the virtual character and the weapon crosshair direction of the virtual character and the shooting direction of the virtual camera before the second touch operation.

The scope to be claimed by the present disclosure should at least include both of the above.

In an alternative embodiment, when the presented visual field of the game scene is changed by the second touch control region, at least one of the displacement and the rotation of the virtual character may be changed by the first touch control region. That is, it is able to change at least one of the orientation of the virtual character and the direction of the weapon crosshair by the first touch operation in the first touch control region while observing the enemy situation by changing the presented visual field with the touch control in the second touch control region, thereby realizing rapid observation and cooperative operation.

In an alternative embodiment, the end of the second touch operation is detected and the second touch control region does not receive a touch operation within the predetermined time period, then the presented visual field of the game scene on the graphical user interface is restored to the status before the second touch operation.

By providing the second touch control region on the graphical user interface and according to the detected second touch operation occurring in the second touch control region, i.e., the presented visual field of the game scene on the graphical user interface may be changed according to the second touch operation received by the second touch control region, when the second touch operation ends, the presented visual field of the game scene on the graphical user interface is restored to the original state. The second touch operation of the user in the second touch control region may change the presented visual field of the game scene on the graphical user interface, and when the second touch operation ends, the state is restored to the state before the second touch operation, providing the user with a convenient and fast way to adjust the presented visual field to meet the needs of the user and improve the user experience.

It is to be noted that the drawings above are merely illustrative explanations of processes included in the method according to the illustrative embodiments of the present disclosure but nor for purpose of limitation. It's readily understood that, the processes illustrated in the drawings above are not intended to indicate or define any time sequence of these processes. Moreover, it's also readily understood that, these processes can also be performed in several components synchronously or asynchronously.

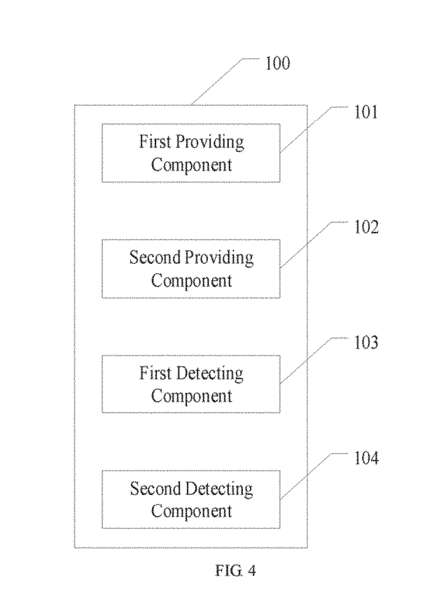

Also disclosed in the illustrative embodiment is a display control apparatus for a game screen. Referring to FIG. 4, the game screen comprises a graphical user interface obtained by executing a software application on a processor of a mobile terminal and rendering on a display of the mobile terminal, the content presented by the graphical user interface includes a game scene and at least partially includes a virtual character. The display control apparatus 100 of the game screen may comprise a first providing component 101, a second providing component 102, a first detecting component 103, and a second detecting component 104.

The first providing component 101 may be configured to provide a first touch control region on the graphical user interface, and to configure the virtual character to perform at least one of the actions: displacement and rotation in the game scene according to a first touch operation received by the first touch control region.

The second providing component 102 may be configured to provide a second touch control region on the graphical user interface, and to configure a presented visual field of the game scene on the graphical user interface to be changed according to a second touch operation received by the second touch control region.

The first detecting component 103 may be configured to detect the second touch operation located in the second touch control region, and to change the presented visual field of the game scene on the graphical user interface according to the second touch operation.

The second detecting component 104 may be configured to detect the end of the second touch operation, and to control the presented visual field of the game scene on the graphical user interface to be restored to the state before the second touch operation.

The specific details of each aforesaid component of the display control apparatus for a game screen have been described in details in the corresponding display control method for a game screen, and therefore will not be described herein.

It should be noted that, although several components or units of the device for executing actions have been mentioned in the detailed description above, such division is not intended to be compulsory. Actually, according to the implementation(s) of the present disclosure, feature(s) and function(s) of one or more components or units described above can be embodied in a single component or unit. On the contrary, feature(s) and function(s) of one or more components or units described above can be embodied by being further divided into multiple components or units.

In an illustrative embodiment of the present disclosure, a computer readable storage medium is provided to have a computer program stored thereon, the aforesaid display control method for a game screen is implemented when the computer program is executed by a processor.

The computer-readable storage medium can include a data signal propagating in a baseband or propagating as a part of a carrier wave, the data signal carries a readable program code. Such propagating data signal can adopt a plurality of forms, including but not limited to electromagnetic signal, optical signal or any appropriate combination of the above. The computer-readable storage medium can send, propagate or transmit a program configured to be utilized by an instruction execution system, apparatus or device or utilized in combination there-with.

The program code embodied in the computer readable storage medium may be transmitted by any suitable medium, including but not limited to wireless, wire line, optical cable, radio frequency, and the like, or any suitable combination of the foregoing.

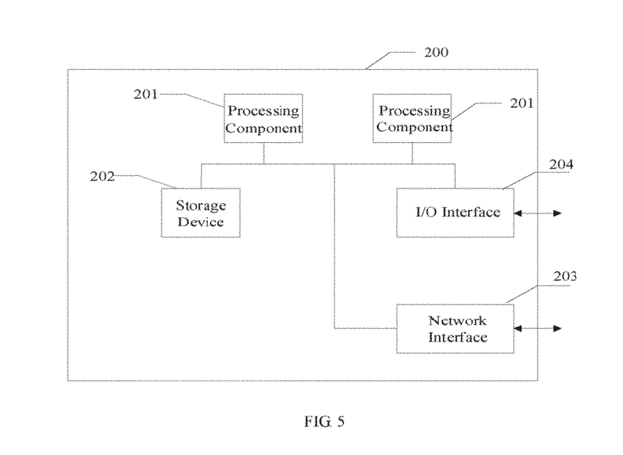

In an illustrative embodiment of the present disclosure, an electronic device is also provided. As shown in FIG. 5, the electronic device 200 includes a processing component 201, one or more processors, and a storage device resource represented by storage device 202 for storing instructions executable by processing component 201, such as an application. An application stored in storage device 202 can include one or more components each corresponding to a set of instructions. In addition, the processing component 201 is configured to execute an instruction to perform the display control method for a game screen described above.

The electronic device 200 may further include: a power supply component configured to perform, power management on the execution of the electronic device 200; a wired or wireless network interface 203 configured to connect the electronic device 200 to the network; and an input and output (I/O) interface 204. The electronic device 200 may operate based on an operating system stored in the storage device, such as Android, iOS, Windows Server™, Mac OS X™, Unix™, Linux™, FreeBSD™ or the like.

In a display control method for a game screen provided by an illustrative embodiment of the present disclosure, a first touch control region is provided on the graphical user interface, and a virtual character is controlled to perform at least one of the action displacement and rotation in the game scene according to a first touch operation received by the first touch control region, a second touch control region is provided on the graphical user interface, and a presented visual field of the game scene on the graphical user interface is changed when a second touch operation is detected in the second touch control region. Upon detecting that the second touch operation has ended, the presented visual field of the game scene on the graphical user interface is controlled to be restored to a state before the second touch operation. On one hand by providing the first touch control region on the graphical user interface and according to the detected first touch operation occurring in the first touch control region, i.e., at least one of the displacement and the rotation may be performed in the same scene according to the first touch operation received by the first touch control region; on the other hand, by providing the second touch control region on the graphical user interface and according to the detected second touch operation occurring in the second touch control region, i.e., the presented visual field of the game scene on the graphical user interface may be changed according to the second touch operation received by the second touch control region, when the second touch operation ends, the presented visual field of the game scene on the graphical user interface is restored to the original state. The second touch operation of the user in the second touch control region may change the presented visual field of the game scene on the graphical user interface, and when the second touch operation ends, it is restored to a state before the second touch operation, providing the user with a convenient and fast way to adjust the presented visual field to meet the needs of the user and improve the user experience.

From the description of the embodiments above, those skilled in the art should be readily appreciated that, the illustrative embodiment(s) described herein can be implemented in the form of software, can also be implemented in the form of software combined with necessary hardware. Therefore, technical solution(s) according to embodiment(s) of the present disclosure can be embodied in the form of software product which can be stored in a nonvolatile storage medium (e.g., CD-ROM, USB flash disk, mobile hard disk, etc.) or in a network, including several instructions allowing a computing device (e.g., personal computer, server, terminal device or network device) to perform the method according to the embodiment(s) of the present disclosure.

Those skilled in the art, by considering the present specification and practicing the disclosure herein, will readily conceive of other embodiment(s) of the present disclosure. The present disclosure is intended to cover any variation, purpose or adaptive modification which is in accordance with general principle(s) of the present disclosure and to encompass well-known knowledge or conventional technical means in the art which is not disclosed in the present disclosure. The specification and the embodiments are merely deemed as illustrative, and the true scope and inspirit of the present disclosure are indicated by the appended claims.

It should be appreciated that, the present disclosure is not intended to be limited to any exact structure described above or illustrated in the drawings, and can be modified and changed without departing from the scope thereof. The scope of the present disclosure is defined by the appended claims.

What is claimed is:

1. A display control method for a game screen, wherein a graphical user interface is obtained by executing a software application on a processor of a mobile terminal and rendering on a touch screen of the mobile terminal, contents displayed by the graphical user interface including a game scene and a partial virtual character, and the method comprising:
providing a first touch control region on the graphical user interface, and configuring the virtual character to perform at least one of displacement and rotation in the game scene according to a first touch operation received by the first touch control region;
providing a second touch control region on the graphical user interface, and configuring a presented visual field of the game scene on the graphical user interface to be changed according to a second touch operation received by the second touch control region;
detecting the second touch operation in the second touch control region, and changing the presented visual field of the game scene on the graphical user interface according to the second touch operation; and
detecting an end of the second touch operation, and controlling the presented visual field of the game scene on the graphical user interface to be restored to a state before the second touch operation.

2. The display control method for a game screen according to claim 1, wherein the first touch control region is a virtual joystick control region.

3. The display control method for a game screen according to claim 1, wherein the second touch operation is a sliding touch operation.

4. The display control method for a game screen according to claim 3, wherein said changing the presented visual field of the game scene on the graphical user interface according to the second touch operation comprises:
changing the presented visual field of the game scene on the graphical user interface according to a sliding trajectory of the sliding touch operation.

5. The display control method for a game screen according to claim 3, wherein said changing the presented visual field of the game scene on the graphical user interface according to the second touch operation comprises:
changing a position of a virtual camera in the game scene to a preset position; and
changing a direction of the virtual camera according to a sliding trajectory of the sliding touch operation.

6. The display control method for a game screen according to claim 3, wherein the game screen is a first person view game screen, and said changing the presented visual field of the game scene on the graphical user interface according to the second touch operation comprises:
switching the first person view game screen to a third person view game screen, and changing a direction of the presented visual field of a game scene on the graphical user interface according to a sliding trajectory of the sliding touch operation.

7. The display control method for a game screen according to claim 1, wherein the second touch operation is a touch click operation.

8. The display control method for a game screen according to claim 7, wherein said changing the presented visual field of the game scene on the graphical user interface according to the second touch operation comprises:
changing the presented visual field of the game scene on the graphical user interface according to the click position of the touch click operation and the position of a preset point in the second touch control region.

9. The display control method for a game screen according to claim 7, wherein said changing the presented visual field of the game scene on the graphical user interface according to the second touch operation comprises:
changing the presented visual field of the game scene on the graphical user interface according to the click position of the touch click operation and the position of a preset line in the second touch control region.

10. The display control method for a game screen according to claim 1, wherein said providing a second touch control region on the graphical user interface comprises:
in response to detecting a preset touch operation on the graphical user interface, presenting the second touch control region on the graphical user interface.

11. The display control method for a game screen according to claim 7, wherein the preset touch operation includes any one of the following: a heavy press, a long press, and a double-click.

12. The display control method for a game screen according to claim 1, wherein said controlling the presented visual field of the game scene on the graphical user interface to be restored to a state before the second touch operation comprises:
controlling the presented visual field of the game scene on the graphical user interface to be restored to the presented visual field before the second touch operation; or
controlling the presented visual field of the game scene on the graphical user interface to be restored to a logically calculated presented visual field calculated according to the presented visual field before the second operation.

13. A display control apparatus for a game screen, wherein a graphical user interface is obtained by executing a software application on a processor of a mobile terminal and rendering on a touch screen of the mobile terminal, contents displayed by the graphical user interface including a game scene and a partial virtual character, and the apparatus comprising:
a first providing component, configured to provide a first touch control region on the graphical user interface, and to configure the virtual character to perform at least one of displacement and rotation in the game scene according to a first touch operation received by the first touch control region;
a second providing component, configured to provide a second touch control region on the graphical user interface, and to configure a presented visual field of the game scene on the graphical user interface to be changed according to a second touch operation received by the second touch control region;
a first detecting component, configured to detect the second touch operation located in the second touch control region, and to change the presented visual field of the game scene on the graphical user interface according to the second touch operation; and
a second detecting component, configured to detect end of the second touch operation, and to control the presented visual field of the game scene on the graphical user interface to be restored to a state before the second touch operation.

14. A computer readable storage medium stored with a computer program, wherein the display control method for a game screen according to claim 1 is implemented when the computer program is executed by a processor.

15. An electronic device, comprising:
a processor; and
a storage device configured to store instructions executed by the processor;
wherein the processor is configured to perform a display control method for a game screen by executing the executable instruction, wherein a graphical user interface is obtained by executing a software application on a processor of a mobile terminal and rendering on a touch screen of the mobile terminal, contents displayed by the graphical user interface including a game scene and a partial virtual character and the processor is configured to;
provide a first touch control region on the graphical user interface, and configure the virtual character to perform at least one of displacement and rotation in the game scene according to a first touch operation received by the first touch control region;
provide a second touch control region on the graphical user interface, and configure a presented visual field of the game scene on the graphical user interface to be changed according to a second touch operation received by the second touch control region,
detect the second touch operation in the second touch control region, and change the presented visual field of the game scene on the graphical user interface according to the second touch operation; and
detect an end of the second touch operation, and control the presented visual field of the game scene on the graphical user interface to be restored to a state before the second touch operation.

16. The electronic device according to claim 15, wherein the first touch control region is a virtual joystick control region.

17. The electronic device according to claim 15, wherein the second touch operation is a sliding touch operation.

18. The electronic device according to claim 17, wherein said processor is further configured to:
change the presented visual field of the game scene on the graphical user interface according to a sliding trajectory of the sliding touch operation.

19. The electronic device according to claim 17, wherein said processor is further configured to:
change a position of a virtual camera in the game scene to a present position; and
change a direction of the virtual camera according to a sliding trajectory of the sliding touch operation.

20. The electronic device according to claim 17, wherein the game screen is a first person view game screen, and said processor is further configured to:
switch the first person view game screen to a third person view game screen, and change a direction of the presented visual field of a game scene on the graphical user interface according to a sliding trajectory of the sliding touch operation.
